(19) United States
(12) Patent Application Publication
(10) Pub. No.: US 2008/0303996 A1
(43) Pub. Date: Dec. 11, 2008

(54) OPTICAL COMPENSATION MEMBER, LIQUID CRYSTAL DISPLAY DEVICE, COMPOSITION FOR ALIGNMENT LAYER, AND ALIGNMENT LAYER

(75) Inventors: Kazuhiko Morisawa, Miyagi (JP); Jun Shimizu, Miyagi (JP); Masaharu Senoue, Miyagi (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 12/133,178

(22) Filed: Jun. 4, 2008

(30) Foreign Application Priority Data
Jun. 5, 2007 (JP) 2007-148772

(51) Int. Cl. G02F 1/13363

(52) U.S. Cl. 349/117

(57) ABSTRACT

An optical compensation member is provided and includes an alignment layer, and an optical anisotropic layer composed of liquid crystal molecules and provided on the alignment layer, wherein the alignment layer contains an additive which suppresses transmission of light in a specific wavelength range.

### CROSS REFERENCES TO RELATED APPLICATIONS

The present application claims priority to Japanese Patent Application JP 2007-148772 filed in the Japanese Patent Office on Jun. 5, 2007, the entire contents of which is incorporated herein by reference.

### BACKGROUND

Image display devices, such as cathode-ray tube display devices, plasma display devices, and liquid crystal display devices, which employ various types of display methods, have been widely used. A remote control device, i.e., remote controller, for controlling the operation of a main body of an image display device utilizing infrared communication is provided in almost all types of these image display devices.

FIG. 8 is a graph showing the wavelength distribution of the intensity of signal light transmitted by a typical remote controller (hereinafter referred to as “remote controller signal light”) and the wavelength dependence (sensitivity curve) of the sensitivity of a light-receiving portion to the remote controller signal light. As shown in FIG. 8, infrared radiation having an intensity distribution with a peak having a center wavelength of 940 nm and a full width at half maximum of about 50 nm is used as the remote controller signal light. On the other hand, the light-receiving portion is sensitive to light having a wide wavelength in the range of 850 to 1,150 μm.

Therefore, in an environment where noise due to strong near-infrared radiation is mixed in a wavelength range of 850 to 1,150 nm, the signal to noise ratio (S/N ratio) of remote controller signal light is decreased. Consequently, the communication sensitivity is decreased, thereby decreasing the maximum distance between a remote controller and a main body, at which the operation of the main body can be controlled by the controller.

For example, in a plasma display device, a very large amount of near-infrared radiation is emitted from a plasma display element. This near-infrared radiation decreases the sensitivity of a main unit of the plasma display device to remote controller signals. In addition, since near-infrared radiation is easily reflected by, for example, walls and furniture in a room and clothes of a user, the near-infrared radiation is incident directly or indirectly on other infrared communication devices (such as, a cordless handset of a telephone and remote controllers of, for example, an air conditioner and an optical disk device such as a DVD (digital versatile disk) player) located around the display device, thus causing malfunction of these devices.

To solve this problem, as disclosed in Japanese Unexamined Patent Application Publication No. 2007-108582 (pp. 16-26), it is effective that a near-infrared-absorbing filter containing a material which absorbs light of the near-infrared range is provided on the front face of a plasma display device. Therefore, almost all plasma display devices which are currently produced include such a near-infrared-absorbing filter.

In addition, for example, Japanese Unexamined Patent Application Publication No. 55-21091 (p. 2 and p. 3) discloses a structure in which near-infrared radiation is removed by utilizing light selective reflection by an optical multilayer film instead of using a near-infrared-absorbing filter. By appropriately designing films in such an optical multilayer film filter, the transmittance of visible light can also be increased. Accordingly, such an optical multilayer film filter is more advantageous than the near-infrared-absorbing filter from the standpoint of suppressing a decrease in the luminance.

A transmissive liquid crystal display device used as a full-color display device, such as a liquid crystal television, includes, for example, a liquid crystal display panel and a backlight device which irradiates illuminating light on the back face of the display panel. In general, the liquid crystal display panel is composed of a liquid crystal cell, two polarizers disposed at both sides of the liquid crystal cell, one optical compensation film (retardation film) disposed between the liquid crystal cell and one of the polarizers or two optical compensation films disposed at either side of the liquid crystal cell, and an anti-glare (AG)-processed film or an anti-reflection (AR)-processed film applied on the polarizer disposed at the front face side, and the like. The backlight device is generally composed of, for example, a backlight light source, and a diffusing plate, a diffusion sheet, and a luminance-improving film, all of which are disposed at the light-emitting side of the backlight light source.

FIG. 9 is an emission spectrum of light in the near-infrared wavelength range, the light being emitted from a cold cathode fluorescent lamp (cold-cathode tube) that is generally used as a backlight light source. The amount of near-infrared radiation emitted from a cold cathode fluorescent lamp of a liquid crystal display device is smaller than that emitted from a plasma display element of a plasma display device. Therefore, to date, the generation of interference due to near-infrared radiation emitted from a cold cathode fluorescent lamp has not been recognized as an actual problem. Accordingly, liquid crystal display devices which are currently available on the market do not include a near-infrared-absorbing filter. The structure of a liquid crystal display panel will now be described.

A liquid crystal cell is composed of a liquid crystal material made of rod-like liquid crystal molecules, two substrates in which the liquid crystal material is filled, and electrode layers for applying an electric field to the liquid crystal molecules. Regarding liquid crystal cells, various display modes such as a vertically aligned (VA) mode, an in-plane switching (IPS) mode, an optically compensatory bend (OCB) mode, ferroelectric liquid crystal (FLC) mode, a twisted nematic (TN) mode, and a super twisted nematic (STN) mode have been proposed in accordance with the differences in the alignment state of liquid crystal molecules and in a method of controlling the alignment state.

A polarizer is generally composed of a polarizing film and two transparent protective films. The polarizing film is generally composed of, for example, a uniaxially oriented film such as a polyvinyl alcohol film and iodine or a dichromatic dye held on the film. As the transparent protective films, triacetyl cellulose (TAC) films or the like are applied on both surfaces of the polarizing film for use.

An optical compensation film such as a retardation film is used in various liquid crystal display devices in order to prevent coloring of a liquid crystal layer by canceling out the retardation in light waves generated when light components having different wavelengths pass through the liquid crystal layer, that is, in order to realize a background display of an achromatic color by compensating for the wavelength dispersion characteristic of the liquid crystal layer. Hitherto, an oriented birefringent film has been used as such a retardation film. Recently, in order to realize a film having a higher function, an optical compensation film prepared by forming an optical anisotropic layer composed of liquid crystal molecules on a transparent support has been used (refer to, for example, edited by Teruhiko Yamazaki, Hideaki Kawakami, and Hiroo Hori, Color TFT liquid crystal display (Revised version), Kyoritsu Shuppan Co., Ltd, (2005)).

The optical anisotropic layer mentioned above is formed by forming, on a transparent support, an alignment layer which controls the alignment of liquid crystal molecules, forming, on the alignment layer, a liquid crystal layer on which the liquid crystal molecules are aligned in a predetermined alignment state, and fixing the liquid crystal molecules so as to maintain the alignment state. In this method, in general, liquid crystal molecules having a polymerizable functional group are used as the liquid crystal molecules, and the alignment state of the liquid crystal molecules is fixed by a polymerization reaction.

Optical properties of an optical compensation film are appropriately determined in accordance with optical properties of a liquid crystal cell, optical properties of liquid crystal molecules used in the cell, and the display mode of the liquid crystal cell. Liquid crystal molecules have large birefringence and have various alignment forms. By using such liquid crystal molecules as a material of an optical compensation film, various optical properties which are not achieved by oriented birefringent films used in the related art can be realized. For example, an optical compensation film having the optimum optical properties can be produced in accordance with various display modes of a liquid crystal cell.

A polycarbonate film, a cellulose film, or a norbornene film is preferably used as the transparent support. In producing an optical compensation film using such a support, it is important to control the alignment of liquid crystal molecules on an alignment layer. In some alignment layers, even when the liquid crystal molecules are aligned thereon, the domain is not single, and thus, a desired retardation is not obtained. Furthermore, in general, a polycarbonate film, a cellulose ester film, or a norbornene film is swelled by an organic solvent or easily dissolved in an organic solvent. Therefore, when an alignment material is provided by application, a solvent that can be used in the application is limited.

In recent years, as an example of thin televisions, which have been becoming increasingly available in large sizes, a liquid crystal display device having a large display screen has been produced. As the size of the display screen increases, the amount of near-infrared radiation emitted from the cold cathode fluorescent lamps of such a large liquid crystal display device tends to increase gradually.

As a structure for removing near-infrared radiation emitted from cold cathode fluorescent lamps, similarly to plasma display devices, a structure in which an optical filter containing a material which absorbs near-infrared radiation is provided on the front face of a liquid crystal display device is conceivable. However, such a material which absorbs near-infrared radiation also has a property of absorbing light in the visible range. Therefore, this stricture causes a decrease in the luminance of the display device. For example, there is generally a decrease of 20% or more in the luminance of a plasma display device caused by the presence of a near-infrared-absorbing filter.

As described above, no near-infrared-absorbing filter is provided in liquid crystal display devices which are currently available on the market. Accordingly, users consider the luminance of the existing liquid crystal televisions as standard. Therefore, in the case where a near-infrared-absorbing filter is provided, users will not purchase liquid crystal display devices equipped with such a filter unless a decrease in the luminance due to the presence of the filter is compensated for by a method for maintaining luminance so as to be substantially the same as that of existing liquid crystal televisions.

A method of compensating for a decrease in the luminance of a backlight device is a method in which the tube current of a cold cathode fluorescent lamp is increased to increase the illuminance of the cold cathode fluorescent lamp. However, as the tube current increases, the temperature in the tube also increases, thereby decreasing the luminous efficiency. Therefore, an improvement in the illuminance by an increase in the tube current is limited. In general, in cold cathode fluorescent lamps which are currently used in a backlight device, the upper limit of an increase in the illuminance caused by an increase in the tube current is about 10%.

The use of an optical multilayer film filter can increase the transmittance of visible light. Accordingly, such an optical multilayer film filter is more advantageous than a near-infrared-absorbing filter in view of suppression of a decrease in the luminance. However, in most cases, the production cost of the optical multilayer film filter is significantly higher than that of the near-infrared-absorbing filter because, for example, the production process includes a large number of steps, and a high accuracy of the film thickness is necessary for each of the layers. Furthermore, in the case where an optical multilayer film filter is additionally formed on the surface of a liquid crystal display device, the luminance of the liquid crystal display device is decreased by the effect of surface reflection of the optical multilayer film filter. When an antireflective layer is provided on the surface of the optical multilayer film filter in order to prevent the decrease in the luminance, adverse effects, such as a decrease in the near-infrared-ray-absorbing performance and an increase in the cost, also occur.

In view of the above circumstances, it is desirable to provide an optical compensation member which has a function of an optical filter and which can be used for, for example, preventing a decrease in the sensitivity of a remote controller and malfunction which are caused by near-infrared radiation emitted from a backlight device, a liquid crystal display device including the optical compensation member, a composition for an alignment layer, which is used as a material of the optical compensation member, and an alignment layer, which is used as a component of the optical compensation member.

### SUMMARY

The present disclosure relates to an optical compensation member having a function of an optical filter, a liquid crystal display device including the optical compensation member, a composition for an alignment layer, which is used as a material of the optical compensation member, and an alignment layer, which is used as a component of the optical compensation member. For example, the present disclosure can be used for preventing a decrease in the sensitivity of a remote controller or malfunction caused by near-infrared radiation emitted from a backlight device of a liquid crystal display device.

An optical compensation member according to an embodiment includes an alignment layer, and an optical anisotropic layer composed of liquid crystal molecules and provided on the alignment layer, wherein the alignment layer contains an additive which suppresses transmission of light in a specific wavelength range. A liquid crystal display device according to an embodiment includes a liquid crystal panel in which the light transmittance is controlled by changing the alignment of liquid crystal molecules in a liquid crystal cell to display an image, wherein the above optical compensation member is provided at one side or both sides of the liquid crystal cell.

According to an embodiment, in a composition for an alignment layer for obtaining an alignment layer which aligns liquid crystal molecules, the composition contains an alignment layer material, and an additive which suppresses transmission of light in a specific wavelength range. Furthermore, an alignment layer according to an embodiment is produced from the above composition for an alignment layer.

A liquid crystal display device according to an embodiment includes a liquid crystal panel in which the light transmittance is controlled by changing the alignment of liquid crystal molecules in a liquid crystal cell to display an image, wherein the optical compensation member according to an embodiment is provided at one side or both sides of the liquid crystal cell. In the optical compensation member according to an embodiment, the alignment layer contains an additive which suppresses transmission of light in a specific wavelength range. Accordingly, the optical compensation member also functions as an optical filter.

Therefore, according to the liquid crystal display device according to an embodiment, the effect of an optical filter can be achieved without providing an optical filter separately. As a result, the layer structure of the liquid crystal panel can be simplified, which is advantageous in terms of cost, as compared with a structure in which an optical filter is separately added to a liquid crystal display device in the related art. Furthermore, loss of light due to reflection and absorption between layers is decreased, as compared with such an existing structure. Accordingly, the image quality such as the luminance can be improved. In addition, even when there are adverse effects caused by the addition of the additive, the effects can be minimized because the additive is added not to the liquid crystal cell, which plays a main role in forming an image, and the polarizing film provided at one side or both sides of the liquid crystal cell but to the optical compensation member used as a compensation component.

The alignment layer can be easily prepared by providing a composition for an alignment layer, the composition containing the additive, on a transparent support or the like by, for example, an application method. This alignment layer can be easily prepared and is advantageous in terms of cost, as compared with the case where an optical multilayer film is formed. Furthermore, as in an existing optical compensation member, the optical compensation member according to an embodiment compensates for the wavelength dispersion characteristic of the liquid crystal layer to realize the background display of an achromatic color. In addition, the optical compensation member according to an embodiment has a function of improving viewing angle characteristics of the liquid crystal display device, such as the luminance, the chromaticity, and the contrast.

The composition for an alignment layer according to an embodiment is a material necessary for obtaining the optical compensation member according to an embodiment. The alignment layer according to an embodiment is a component necessary for obtaining the optical compensation member according to an embodiment.

Additional features and advantages are described herein, and will be apparent from the following Detailed Description and the figures.

### BRIEF DESCRIPTION OF THE FIGURES

FIGS. 1A and 1B include cross-sectional views of the relevant part of a liquid crystal display panel showing an example of the structure of optical compensation films according to an embodiment;

FIG. 2 is a cross-sectional view showing the relevant part of the structure of a transmissive liquid crystal display device according to an embodiment;

FIG. 3 is a plan view showing the arrangement of devices used when the maximum distance at which the operation with a remote controller can be performed is measured, according to Examples;

FIGS. 4A to 4C are graphs each showing a spectral transmittance curve of an optical compensation film according to an Example;

FIGS. 5A to 5C are graphs each showing a spectral transmittance curve of an optical compensation film according to an Example;

FIGS. 6A and 6B are graphs each showing a spectral transmittance curve of an optical compensation film according to an Example;

FIG. 7 is a graph showing a spectral transmittance curve of an optical compensation film according to a Comparative Example;

FIG. 8 is a graph showing the wavelength distribution of the intensity of signal light transmitted by a typical remote controller and the wavelength dependence (sensitivity curve) of the sensitivity of a light-receiving portion; and

FIG. 9 is an emission spectrum of light in the near-infrared wavelength range, the light being emitted from a cold cathode fluorescent lamp which is generally used as a backlight light source.

### DETAILED DESCRIPTION

In an optical compensation member according to an embodiment, a light-absorbing material which absorbs light in a specific wavelength range is preferably contained as an additive in an alignment layer. From the standpoint of availability and ease of handling, as the additive, the light-absorbing material which absorbs light in the specific wavelength range is preferable. However, the additive is not limited thereto. Alternatively, fine particles may be added as the additive, and reflection and scattering caused by the presence of these fine particles may be utilized.

In addition, the transmittance of light transmitting through the alignment layer is preferably controlled by the concentration of the additive contained in the alignment layer and/or the thickness of the alignment layer.

Furthermore, preferably, the alignment layer easily transmits light in the visible range and suppresses the transmission of light in the near-infrared range included in light emitted from a backlight light source of a transmissive liquid crystal display device. This structure can suppress transmission of near-infrared radiation emitted from a backlight device, for example, a cold cathode fluorescent lamp, while minimizing a decrease in the luminance of the liquid crystal display device. Consequently, this structure can prevent a decrease in the sensitivity of a remote controller of the liquid crystal display device and malfunction of other infrared communication devices located around the liquid crystal display device, which are caused by near-infrared radiation emitted from the backlight light source.

In the case where the optical compensation member according to an embodiment is applied to the transmissive liquid crystal display device, as a preferred example, the alignment layer includes an alignment layer material and a near-infrared-absorbing material, which is the above additive. In this case, the near-infrared-absorbing material is preferably composed of at least one near-infrared-absorbing agent selected from a diimmonium compound, an aminium salt, an iminium salt, a diiminium salt, a quinone compound, a cyanine dye, a phthalocyanine compound, a naphthalocyanine compound, and a metal complex compound. The alignment layer material is preferably a cellulose resin or a polyamide-imide resin. These resins can be dispersed in a solvent together with the near-infrared-absorbing material. Accordingly, an alignment layer containing the near-infrared-absorbing material can be easily formed by an application method. In addition, the resulting material has a strong action for aligning liquid crystal molecules.

In addition, the average transmittance for light having a wavelength in the range of 400 to 700 nm is preferably 85% or more, and the average transmittance for light having a wavelength in the range of 850 to 1,150 nm is preferably 80% or less. The reason for this is as follows. If the average transmittance for light having a wavelength in the range of 400 to 700 nm is less than 85%, the luminance reduction ratio of a liquid crystal display device becomes more than 10%, which is not corrected by increasing the tube current of cold cathode fluorescent lamps. If the average transmittance for light having a wavelength in the range of 850 to 1,150 nm is more than 80%, operation interference to a remote controller due to near-infrared radiation emitted from a backlight light source is hardly suppressed. According to the above optical compensation member, by integrating an optical compensation film with an optical filter, a decrease in the transmittance in the visible range can be suppressed to realize a luminance reduction ratio of 10% or less.

Preferably, the liquid crystal display device according to an embodiment includes a backlight device and functions as a transmissive liquid crystal display device.

In the composition for an alignment layer according to an embodiment, the additive is preferably a light-absorbing material which absorbs light in a specific wavelength range. (A description is omitted because it is the same as that described above.)

When the liquid crystal display device according to an embodiment is applied to a transmissive liquid crystal display device, the light-absorbing material is preferably a near-infrared-absorbing material which easily transmits light in the visible range and easily absorbs light in the near-infrared range. In this case, the near-infrared-absorbing material is preferably composed of at least one near-infrared-absorbing agent selected from a diimmonium compound, an aminium salt, an iminium salt, a diiminium salt, a quinone compound, a cyanine dye, a phthalocyanine compound, a naphthalocyanine compound, and a metal complex compound. The alignment layer material is preferably a cellulose resin or a polyamide-imide resin.

Preferred embodiments are described below more specifically with reference to the drawings. Various modifications can be made on the basis of the technical spirit and scope of the present disclosure.

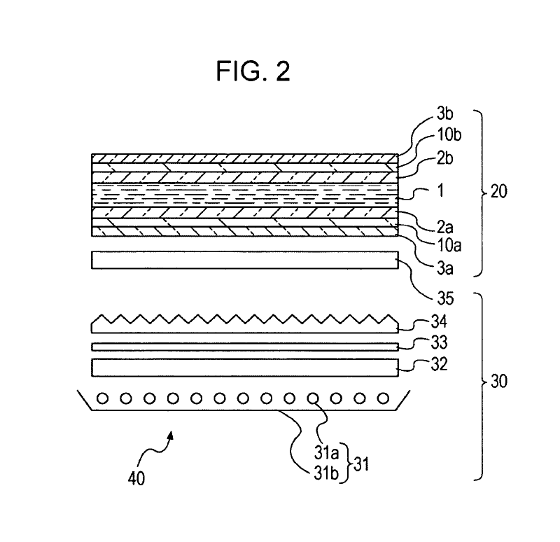

FIG. 2 is a schematic cross-sectional view showing the stricture of a transmissive liquid crystal display device 40 according to an embodiment. The transmissive liquid crystal display device 40 is used as, for example, a large liquid crystal television. As shown in FIG. 2, the transmissive liquid crystal display device 40 is composed of a liquid crystal display panel 20 and a backlight device 30 which irradiates illuminating light on the back face of the panel 20 (the lower side in FIG. 2).

In the liquid crystal display panel 20, a liquid crystal layer 1 and a pair of transparent substrates 2a and 2b sandwiching the liquid crystal layer 1 form a liquid crystal cell. A pair of polarizers 3a and 3b are disposed at the outer surface side of the transparent substrates 2a and 2b, respectively. Furthermore, an optical compensation film 10a is provided between the transparent substrate 2a and the polarizer 3a, and an optical compensation film 10b is provided between the transparent substrate 2b and the polarizer 3b.

The structure of the liquid crystal layer 1 is not particularly limited. For example, a liquid crystal material which has a positive dielectric anisotropy and in which the major axis of each molecule is aligned in a direction substantially parallel to the electric field direction in response to an application of an electric field may be used. Alternatively, a homeotropic liquid crystal material which has a negative dielectric anisotropy and in which the major axis of each molecule is aligned in a direction substantially perpendicular to the electric field direction in response to an application of an electric field may be used.

Each of the transparent substrates 2a and 2b is composed of a glass substrate. Although not shown in the figure, stripe-shaped transparent electrodes, an insulating film, and an alignment layer are provided on the inner surface of the transparent substrate 2a. A color filter of the three primary colors, i.e., red (R), green (G), and blue (B), an overcoat layer, stripe-shaped transparent electrodes, and an alignment layer are provided on the inner surface of the transparent substrate 2b. Each of the alignment layers is made of, for example, a polyimide resin and is provided so as to be in contact with the liquid crystal material.

Each of the optical compensation films 10a and 10b corresponds to the optical compensation member. The optical compensation films 10a and 10b cancel out the retardation in light waves generated when light components having different wavelengths pass through the liquid crystal layer 1 to prevent coloring of the liquid crystal layer 1. That is, the optical compensation films 10a and 10b cancel out the wavelength dispersion characteristics of the liquid crystal layer 1 to realize a background display of an achromatic color. Furthermore, the optical compensation films 10a and 10b suppress a decrease in the luminance, the chromaticity, and the contrast of the liquid crystal display device due to a difference in the viewing angle to improve the viewing angle characteristics of the liquid crystal display device 40, Furthermore, according to a feature of this embodiment, the liquid crystal display panel 20 includes a layer containing a near-infrared-absorbing material which easily transmits light in the visible range and easily absorbs light in the near-infrared range, and this layer functions as a near-infrared-absorbing filter. This feature will be described in detail later.

The backlight device 30 is generally formed by appropriately combining, for example, a backlight light source 31, and a diffusing plate 32, a diffusion sheet 33, a prism sheet 34, and a polarization separation element 35, all of which are disposed at the light-emitting side of the backlight light source 31.

The backlight light source 31 is a direct backlight light source which irradiates illuminating light from the back face of the liquid crystal display panel 20. The backlight light source 31 includes, for example, a linear light source 31a composed of a plurality of cold cathode fluorescent lamps (CCFLs) and a reflector 31b covering the back face and the side faces of the linear light source 31a. Light emitted from the backlight light source 31 (light from a backlight) enters the liquid crystal display panel 20 through the various optical films 32 to 35.

The diffusing plate 32 scatters the light emitted from the backlight light source 31 (light from the backlight) and averages the variation in the light path to make the luminance uniform so that the emission lines of the backlight light source 31 are not seen from the liquid crystal display panel 20 side. The diffusion sheet 33 diffuses the light from the backlight to a predetermined angle range. The prism sheet 34 condenses the light from the backlight diffused by the diffusion sheet 33 and allows the light to be incident on the polarization separation element 35. The polarization separation element 35 transmits a linear polarization component of the incident light in a certain direction and reflects other linear polarization components thereof. Accordingly, only polarized light in the certain direction enters the liquid crystal display panel 20.

The polarized light passed through the polarization separation element 35 passes through the polarizer 3a having a transmission axis parallel to the polarization direction of the light, and incident on the liquid crystal layer 1 through the optical compensation film 10a and the transparent substrate 2a. Liquid crystal molecules constituting the liquid crystal layer 1 are driven by a voltage applied between transparent electrodes in each pixel area sandwiched between the transparent electrodes to control the alignment direction of the liquid crystal molecules. The polarization direction of the incident light is changed by the aligned liquid crystal molecules while the light passes through the liquid crystal layer 1. As a result, the amount of light passing through the polarizer 3b disposed at the front face side of the liquid crystal display panel 20 is controlled in each pixel. Accordingly, an image is formed on the front face of the liquid crystal display panel 20.

Each of the cold cathode fluorescent lamps 31a constituting the backlight light source 31 is generally filled with argon (Ar) gas and mercury (Hg) vapor. Accordingly, as shown in FIG. 9, the cold cathode fluorescent lamps 31a emit near-infrared radiation including three emission lines due to Ar, which have peak wavelengths of 912 nm, 922 nm, and 965 nm, and an emission line due to Hg, which has a peak wavelength of 1,013 μm. The amount of generation of the three emission lines due to Ar is large immediately after the power is supplied, and decreases as time goes on. In contrast, the emission line peak due to Hg increases as the temperature in the cold cathode fluorescent lamps increases to increase the mercury vapor pressure.

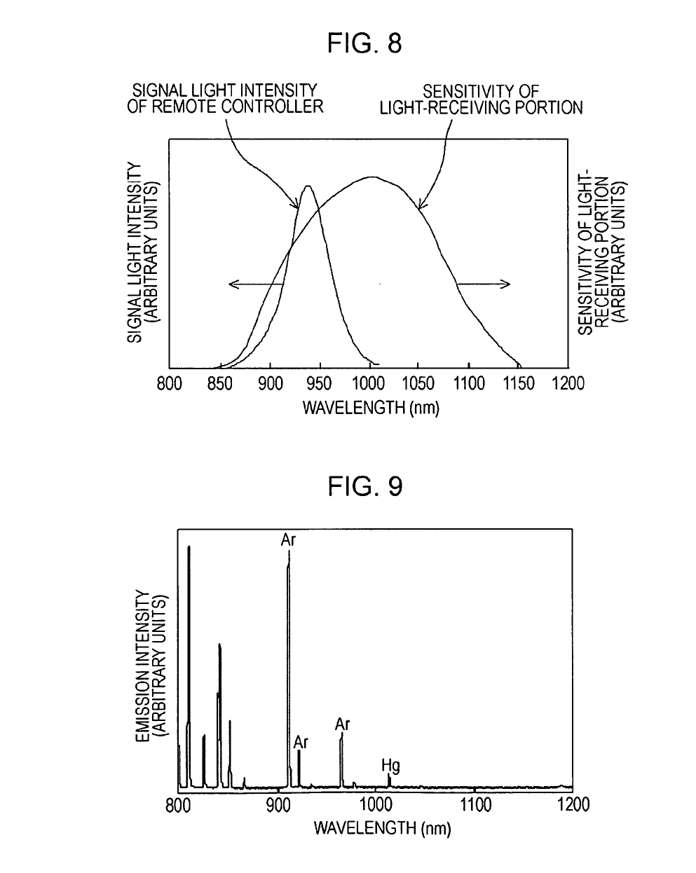

These emission lines lie in the wavelength range which is included in the sensitivity of a light-receiving portion of a remote controller (refer to FIG. 8). Accordingly, these emission lines not only decrease the sensitivity of the main body of the liquid crystal display device to remote controller signals, but also cause malfunction of other infrared communication devices located around the liquid crystal display device. Accordingly, in this embodiment, the optical compensation films 10a and 10b are provided with a function of a near-infrared-absorbing filter which easily transmits light in the visible range and easily absorbs light in the near-infrared range included in the light emitted from the backlight light source 31.

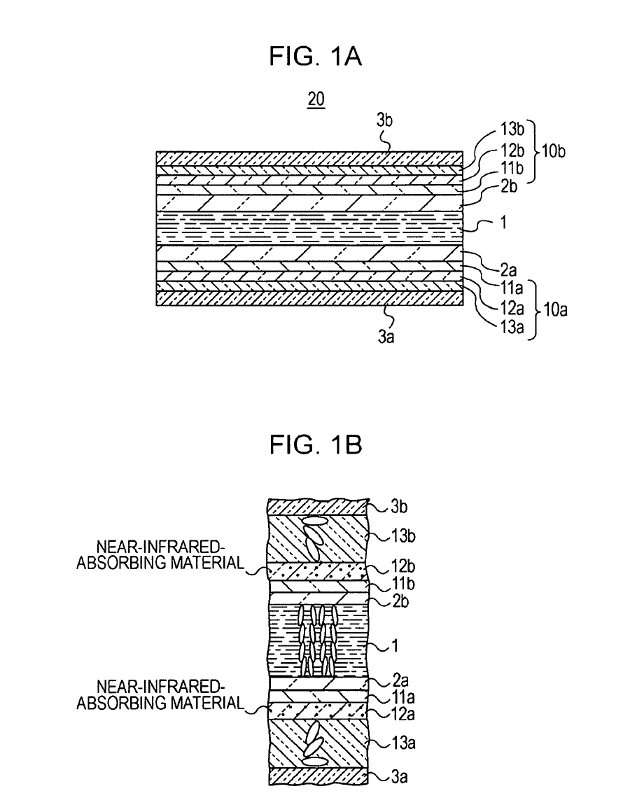

FIG. 1A is a cross-sectional view of the relevant part of a liquid crystal display panel 20 showing an example of the structure of optical compensation films 10 according to this embodiment. FIG. 1B is a cross-sectional view mainly illustrating the feature of this embodiment. (Hereinafter, reference numerals 10a and 10b are represented as reference numeral 10 in common. Other components are also represented in the similar manner.) As shown in FIGS. 1A and 1B, the optical compensation film 10 includes a retardation film 11 having optical anisotropy in the in-plane direction and a retardation film (i.e., optical anisotropic layer) 13 having optical anisotropy in the thickness direction.

It is known that, as the retardation layer having optical anisotropy in the thickness direction, formation of an optical anisotropic layer composed of aligned liquid crystal molecules is effective. Consequently, in the optical compensation film 10, the retardation film 11 having optical anisotropy in the in-plane direction is used as a transparent support, a near-infrared-absorbing material-containing alignment layer 12 is formed on the retardation film 11, and the optical anisotropic layer 13 having predetermined optical anisotropy in the thickness direction and composed of aligned liquid crystal molecules is further formed on the alignment layer 12.

The retardation film 11 is not particularly limited. A transparent and oriented film having in-plane retardation, for example, a film called “A-plate” is preferably used as the retardation film 11. Specific examples of the retardation film 11 include transparent films composed of a norbornene resin, a polyester resin, a cellulose resin, a polyethylene resin, a polypropylene resin, a polyolefin resin, a polycarbonate resin, a phenolic resin, and a copolymer thereof.

The retardation film 11 may optionally contain various types of additives, as long as the are not impaired. Examples of the additives include an antistatic agent, a UV (ultraviolet) absorber, and a stabilizing agent. In addition, in order to control retardation, birefringent metal oxide fine particles may be added to the retardation film 11. However, in order to keep the transparency of the film, preferably, inert particles which are added to a polyester resin for the purpose of an improvement of handleability (such as easy slidability, windability, and blocking resistance) of a film thereof are not substantially contained.

Regarding the feature of this embodiment, each of the near-infrared-absorbing material-containing alignment layers 12 is prepared by dispersing a near-infrared-absorbing dye in an alignment layer material. Therefore, the alignment layer 12 has a wavelength characteristic in which light in the visible range is easily transmitted and light in the near-infrared range is easily absorbed in the light emitted from the backlight light source 31. The alignment layer 12 also functions as an optical filter which attenuates light in the near-infrared range. Two or more types of dyes may be mixed and dispersed in the near-infrared-absorbing material-containing alignment layer 12. The near-infrared-absorbing material-containing alignment layer 12 may be provided at both sides of the retardation film 11 or at either one side of the retardation film 11.

Examples of the alignment layer material include, but are not particularly limited to, polyamide-imide resins, polyimide resins, polyamide resins, acrylic resins, cellulose resins, and polyvinyl alcohol resins. However, from the standpoint that the dispersion state of the near-infrared-absorbing material is stably maintained, the glass transition temperature of the alignment layer material is preferably equal to or higher than the guaranteed operation temperature of the liquid crystal display device 40 including the optical compensation film 10.

The material constituting near-infrared-absorbing dye is also not particularly limited. Preferable examples of the material include diimmonium compounds, aminium salts, iminium salts, diiminium salts, quinone compounds, cyanine dyes, phthalocyanine compounds, naphthalocyanine compounds, metal complex compounds, and mixtures thereof.

The transmittance of light transmitting through the near-infrared-absorbing material-containing alignment layer 12 can be controlled by the dye concentration in the alignment layer 12 and/or the thickness of the alignment layer 12 containing the dye. More specifically, each of the near-infrared-absorbing material-containing alignment layers 12 is formed so that the average transmittance for visible light having a wavelength in the range of 400 to 700 nm is 85% or more. In addition, each of the alignment layers 12 is formed so that the average transmittance for the near-infrared light having a wavelength in the range of 850 to 1,150 nm, to which a light-receiving portion of a typical remote controller is sensitive, is 80% or less. In this case, more preferably, the alignment layer 12 is formed so that the transmittance becomes minimum in the above near-infrared range.

Further preferably, the near-infrared-absorbing material-containing alignment layers 12 are formed so that the luminance reduction ratio of the liquid crystal display device decreased by forming the alignment layers 12 is 10% or less. In such a case, the decrease in the luminance caused by the formation of the near-infrared-absorbing material-containing alignment layers 12 can be completely compensated for by increasing the tube current of the cold cathode fluorescent lamps 31a and increasing the illuminance of the cold cathode fluorescent lamps 31a.

In preparation of the optical compensation film 10, in the case where an organic substrate is used as the retardation film 11 and the optical anisotropic layer 13 composed of liquid crystal molecules is formed on the retardation film 11, in general, the near-infrared-absorbing material-containing alignment layer 12 is formed by an application method or the like. A rubbing treatment is then performed, and a liquid crystal material is applied on the alignment layer 12 to form a liquid crystal molecule layer in which liquid crystal molecules are aligned in a predetermined alignment state. Thus, a liquid crystal molecule layer having retardation satisfying a desired viewing-angle compensation function can be obtained. The liquid crystal molecules in the liquid crystal molecule layer are then fixed while this alignment state is maintained. Accordingly, the optical anisotropic layer 13 is formed, and the optical compensation film 10 can be obtained. In this case, preferably, liquid crystal molecules having a polymerizable functional group are used as the liquid crystal molecules, and the alignment state of the liquid crystal molecules is fixed by a polymerization reaction.

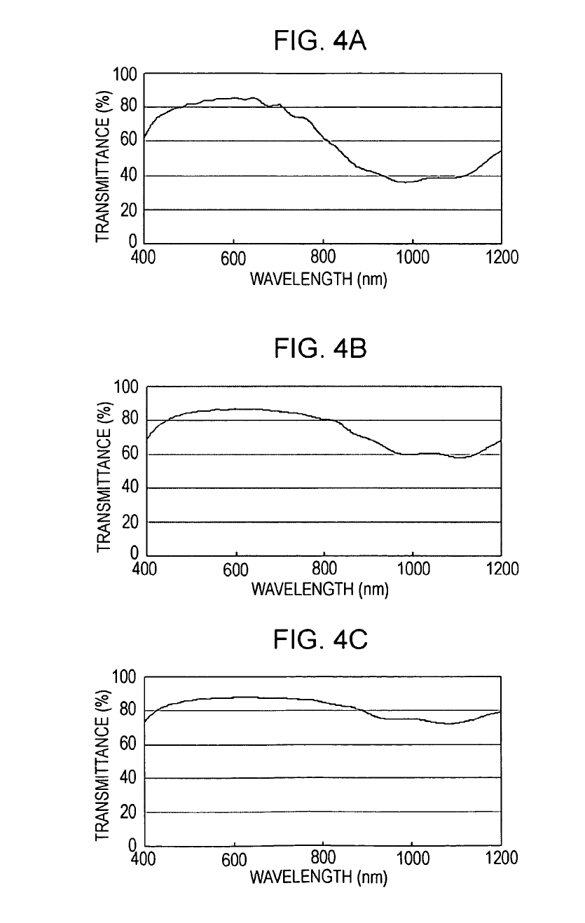

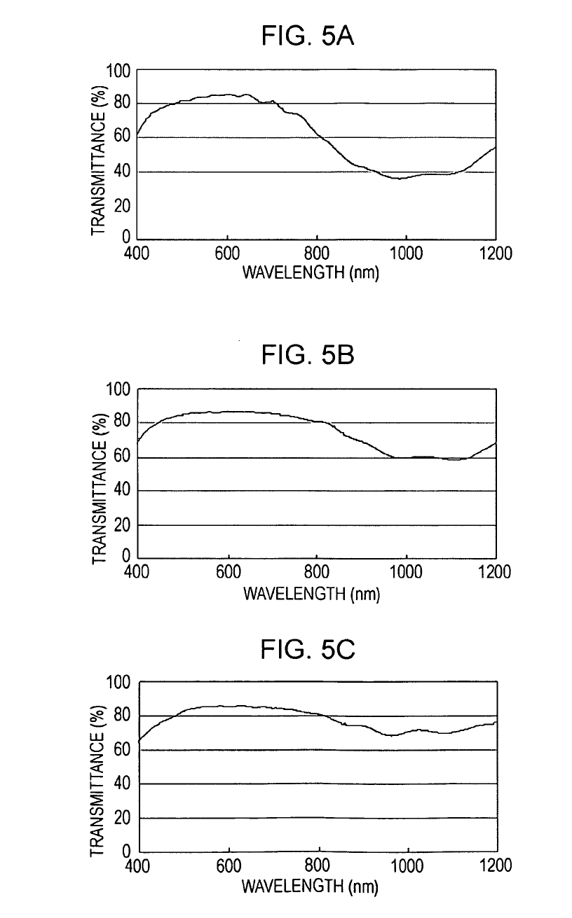

FIGS. 4A to 4C and FIGS. 5A to 5C are graphs each showing a spectral transmittance curve of an optical compensation film 10 including a near-infrared-absorbing material-containing alignment layer 12, the optical compensation film 10 being obtained in an Example described below. As shown in FIGS. 4A to 4C and FIGS. 5A to 5C, in the optical compensation film 10, the near-infrared-absorbing material-containing alignment layer 12 has an increased absorption performance for light having a wavelength in the range of 850 to 1,150 nm, to which a light-receiving portion of a remote controller is sensitive, so that the transmittance of the light is decreased. Accordingly, near-infrared radiation emitted from the backlight light source 31 can be effectively absorbed, and the amount of near-infrared radiation emitted outside the liquid crystal display device 40 can be efficiently decreased.

In particular, in a liquid crystal display device including a backlight composed of cold cathode fluorescent lamps, near-infrared radiation generated in a wavelength range of 850 to 1,150 nm has three emission line peaks due to Ar which are located at 912 nm, 922 nm, and 965 nm, and an emission line peak due to Hg which is located at 1,013 nm. By providing the near-infrared-absorbing material-containing alignment layer 12, the amount of near-infrared radiation having these emission line peaks can be decreased. Accordingly, a decrease in the sensitivity of a remote controller of the liquid crystal display device 40 itself caused by infrared radiation emitted from the liquid crystal display device 40, and malfunction of infrared communication devices located around the liquid crystal display device 40 can be suppressed.

On the other hand, each of the optical compensation films 10 having an optical property shown in FIGS. 4A to 4C and FIGS. 5A to 5C has a high transmittance of light in the visible range. Therefore, the effect on the quality, in particular, the luminance of images of the liquid crystal display device can be reduced.

The transmittance in the near-infrared range of the near-infrared-absorbing material-containing alignment layer 12 is preferably changed in accordance with the screen size of the liquid crystal display device 40 used. More specifically, as the screen size increases, the amount of near-infrared radiation emitted from the backlight light source 31 also increases. Therefore, it is necessary to decrease the transmittance of the ear-infrared-absorbing material-containing alignment layer 12 in accordance with the increase in the near-infrared radiation.

The transmittance of the near-infrared-absorbing material-containing alignment layer 12 in the visible range relates to the luminance of an image displayed on the display device. Specifically, as the transmittance decreases, the luminance also decreases. When it is necessary to control the luminance reduction ratio of an image caused by providing the near-infrared-absorbing material-containing alignment layer 12 inside the display device to be 10% or less, it is necessary to control the average transmittance of the near-infrared-absorbing material-containing alignment layer 12 in the visible wavelength range of 400 to 700 nm to be 85% or more.

In the present embodiment, a description has been made of an example in which the optical compensation films 10 are provided at both sides of the liquid crystal layer 1. Alternatively, the optical compensation film 10 may be provided at only one side of the liquid crystal layer 1. Alternatively, the retardation film 11 may be omitted, and the near-infrared-absorbing material-containing alignment layer 12 and the optical anisotropic layer 13 may be formed on the transparent substrate 2 of the liquid crystal layer 1.

### EXAMPLES

Examples will now be described. However, the Examples below are illustrative, and the present disclosure is not limited to the Examples.

### Example 1

In Example 1, first, the near-infrared-absorbing material-containing alignment layer 12 and the optical compensation film 10 which have been described in the above embodiment with reference to FIGS. 1A and 1B were prepared. The spectral transmittance and retardation of the optical compensation film 10 were then measured. Subsequently, the liquid crystal display device 40 shown in FIG. 2 was produced using the optical compensation film 10. The maximum distance at which the operation with a remote controller can be performed and the luminance reduction ratio at the central portion of a screen were measured using the liquid crystal display device 40.

### <Formation of Near-Infrared-Absorbing Material-Containing Alignment Layer and Optical Compensation Film>

First, a mixed material for an alignment layer used for forming a near-infrared-absorbing material-containing alignment layer 12 by an application method was prepared by uniformly mixing the materials below.

| | |
|---|---|
| Near-infrared-absorbing agent | 1 wt% |
| (dye containing a diimmonium salt) | |
| Alignment layer material | 5 wt% |
| (polyamide-imide resin, manufactured | |
| by Toyobo Co., Ltd.; model number HRI5ET) | |
| Solvent (mixed solvent of toluene: | 94 wt% |
| ethanol: butanol = 1:1:1 by mass ratio) | |

Next, as the retardation film 11, a polycarbonate film (manufactured by Teijin Chemicals Ltd., trade name: Pure Ace) was prepared. The mixed material for an alignment layer prepared above was applied onto the retardation film 11. The application was performed using a spin coater at a rotational speed of 3,000 rpm and an application time of 30 seconds, thus forming a coating film having a thickness of 5,000 μm. After the application, a drying treatment was performed at 85° C. for two minutes. Subsequently, a rubbing treatment was performed at a rotational speed of 245 rpm and a rubbing speed of 1 m/min. Thus, the near-infrared-absorbing material-containing alignment layer 12 was obtained.

Next, a UV (ultraviolet)-curable cholesteric liquid crystal material was applied on the near-infrared-absorbing material-containing alignment layer 12. The liquid crystal material was applied using a spin coater at a rotational speed of 3,500 rpm and an application time of 30 seconds to form a coating film having a thickness of 1.8 μm. After the application, a drying treatment was performed at 80° C. for two minutes. Subsequently, a UV curing treatment was performed under light irradiation of 1,400 mJ/cm². Thus, the optical compensation film 10 was prepared.

FIG. 4A is a graph showing a spectral transmittance curve of the optical compensation film 10 of Example 1. Furthermore, Table 1 shows average transmittances of light having a wavelength in the range of 400 to 700 nm and light having a wavelength in the range of 850 to 1,150 nm. The spectral transmittances were measured using a measurement device manufactured by Shimadzu Corporation (product name: SOLID SPEC 3700 DUV).

The retardation value of the optical compensation film 10 of Example 1 was measured using a measurement device manufactured by Otsuka Electronics Co., Ltd. (product name: RETS-100). This result is shown in Table 1. If this retardation value matches a value obtained from the optical properties of the used cholesteric liquid crystal and the film thickness thereof, molecules of the cholesteric liquid crystal are aligned in the desired manner. By optimizing this retardation, the viewing angle characteristics of the liquid crystal display device can be improved.

Cholesteric liquid crystal molecules are aligned in a state in which rod-like liquid crystal molecules lie in a plane (in the x-axis direction and in the y-axis direction) and are stacked in a spiral shape. Accordingly, when the refractive index in the x-axis direction, the refractive index in the y-axis direction, and the refractive index in the z-axis direction are represented by nx, ny, and nz, respectively, the relationship nx=ny>nz is satisfied. That is, retardation is not generated in the in-plane direction, and the liquid crystal molecule layer has retardation in the thickness direction (in the z-axis direction). Consequently, the alignment state of the liquid crystal was evaluated using the retardation value in the state in which the sample was tilted at 40 degrees.

### <Preparation of Liquid Crystal Display Device>

First, iodine was held on an oriented polyvinyl alcohol film to prepare a polarizer 3. Subsequently, the optical compensation film 10 was bonded on a surface of the polarizer 3 so that the absorption axis of the polarizer 3 was parallel to the slow axis of the optical compensation film 10. Thus, an optical compensation film 10 integrated with the polarizer 3 was obtained.

Next, a ready-made liquid crystal display device was modified to prepare a liquid crystal display device 40. More specifically, a VA liquid crystal cell was taken out from a liquid crystal display device (a 42-inch liquid crystal television manufactured by Sony Corporation) equipped with the VA-type liquid crystal cell, and a pair of polarizers provided on both surfaces of the liquid crystal cell were removed. Subsequently, instead of these polarizers, the optical compensation films 10 each integrated with the polarizer 3 were bonded to the liquid crystal cell using an adhesive at the side of each of the optical compensation films 10. This modified liquid crystal cell was installed in the original liquid crystal display device to prepare the liquid crystal display device 40.

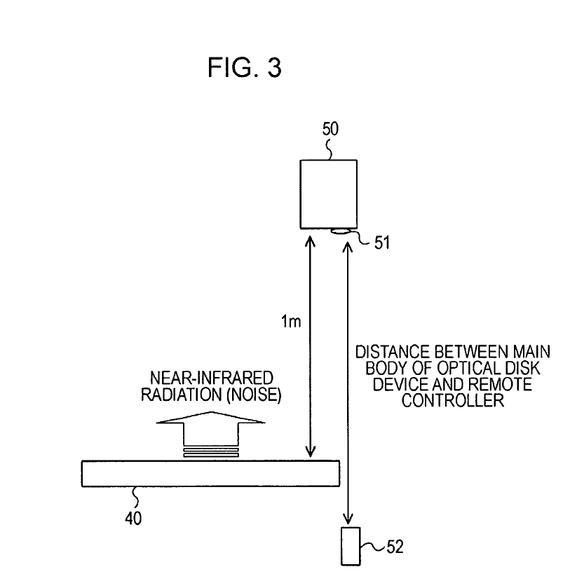

FIG. 3 is a plan view showing the arrangement when the maximum distance at which the operation with a remote controller can be performed is measured, regarding the liquid crystal display device 40. An optical disk device (DVD player manufactured by Sony Corporation) 50 was arranged in front of the side portion of the front face of the liquid crystal display device 40. The liquid crystal display device 40 was arranged to face the optical disk device 50 so that the distance between a display screen of the liquid crystal display device 40 and a remote controller light-receiving portion 51 of the optical disk device 50 was 1 meter.

In this state, immediately after the liquid crystal display device 40 is operated, a tester who had a remote controller 52 stood in front of the remote controller light-receiving portion 51 of the optical disk device 50. The tester determined the maximum distance at which the operation with the remote controller of the optical disk device 50 could be performed by moving away from the optical disk device 50. This distance was defined as “the maximum distance at which the operation with a remote controller can be performed”. It was determined that as this distance became longer, the probability of successful operation of the remote controller increased. The measurement result is shown in Table 3. Note that the signal wavelength range of the remote controller 52 was in the range of 930 to 960 nm, and the light-receiving sensitivity range of the remote controller light-receiving portion 51 was in the range of 850 to 1,150 nm.

Furthermore, the luminance at the central portion of the screen of the liquid crystal display device 40 was measured using a spectral luminance meter (model number: CS1000A, manufactured by Konica Minolta Holdings, Inc.). The ratio of this luminance to the luminance of the liquid crystal display device before the modification was determined as a luminance reduction ratio. The measurement result is shown in Table 3.

### Example 2

In Example 2, an optical compensation film 10 and a liquid crystal display device 40 were produced as in Example 1 except that the thickness of the coating film of the mixed material for an alignment layer was 3,000 nm to decrease the thickness of the near-infrared-absorbing material-containing alignment layer 12. The spectral transmittance and the retardation of the optical compensation film 10 were measured. Regarding the liquid crystal display device 40, the maximum distance at which the operation by a remote controller can be performed and the luminance reduction ratio at the central portion of the screen were measured. The measurement results are shown in FIG. 4B, Table 1, and Table 3.

### Example 3

In Example 3, an optical compensation film 10 and a liquid crystal display device 40 were produced as in Example 1 except that the thickness of the coating film of the mixed material for an alignment layer was 1,000 nm to further decrease the thickness of the near-infrared-absorbing material-containing alignment layer 12. The spectral transmittance and the retardation of the optical compensation film 10 were measured. Regarding the liquid crystal display device 40, the maximum distance at which the operation by a remote controller can be performed and the luminance reduction ratio at the central portion of the screen were measured. The measurement results are shown in FIG. 4C, Table 1, and Table 3.

### Example 4

In Example 4, the mixed material for an alignment layer for forming the near-infrared-absorbing material-containing alignment layer 12 by an application method was changed as follows.

| | |
|---|---|
| Near-infrared-absorbing agent | 1 wt% |
| (dye containing a diimmonium salt) | |
| Alignment layer material (cellulose resin, | 5 wt% |
| manufactured by Shin-Etsu Chemical | |
| Co. Ltd.; trade name 60SH) | |
| Solvent (mixed solvent of ethanol: water: | 94 wt% |
| methyl ethyl ketone = 1:1:0.5 by | |
| mass ratio) | |

An optical compensation film 10 and a liquid crystal display device 40 were produced as in Example 1 except for the above change in the mixed material for an alignment layer. The spectral transmittance and the retardation of the optical compensation film 10 were measured. Regarding the liquid crystal display device 40, the maximum distance at which the operation by a remote controller can be performed and the luminance reduction ratio at the central portion of the screen were measured. The measurement results are shown in FIG. 5A, Table 1, and Table 3.

### Example 5

In Example 5, an optical compensation film 10 and a liquid crystal display device 40 were produced as in Example 4 except that the thickness of the coating film of the mixed material for an alignment layer was 3,000 nm to decrease the thickness of the near-infrared-absorbing material-containing alignment layer 12. The spectral transmittance and the retardation of the optical compensation film 10 were measured. Regarding the liquid crystal display device 40, the maximum distance at which the operation by a remote controller can be performed and the luminance reduction ratio at the central portion of the screen were measured. The measurement results are shown in FIG. 5B, Table 1, and Table 3.

### Example 6

In Example 6, an optical compensation film 10 and a liquid crystal display device 40 were produced as in Example 4 except that the thickness of the coating film of the mixed material for an alignment layer was 800 nm to further decrease the thickness of the near-infrared-absorbing material-containing alignment layer 12. The spectral transmittance and the retardation of the optical compensation film 10 were measured. Regarding the liquid crystal display device 40, the maximum distance at which the operation by a remote controller can be performed and the luminance reduction ratio at the central portion of the screen were measured. The measurement results are shown in FIG. 5C, Table 1, and Table 3.

### Example 7

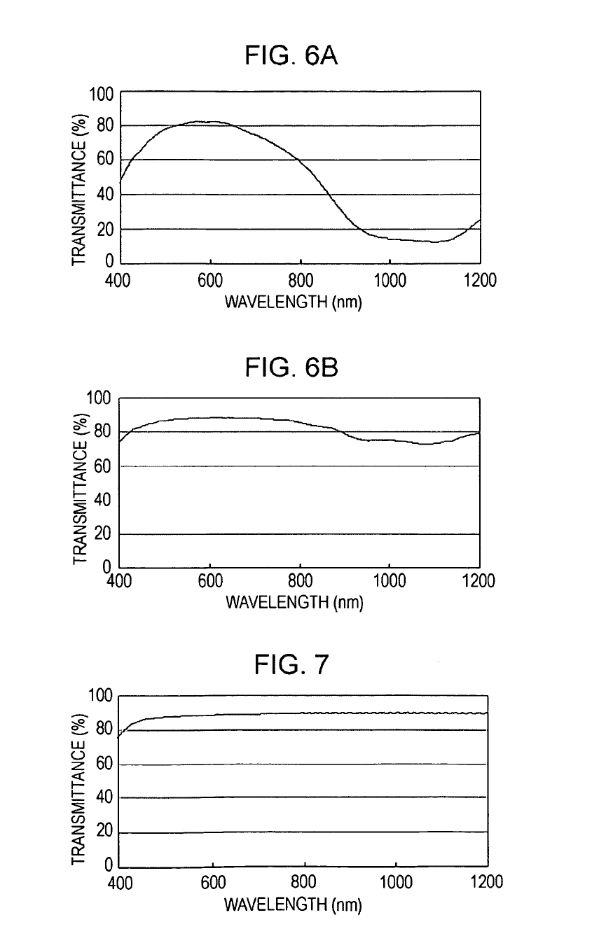

In Example 7, an optical compensation film 10 and a liquid crystal display device 40 were produced as in Example 1 except that the thickness of the coating film of the mixed material for an alignment layer was 8,000 nm to increase the thickness of the near-infrared-absorbing material-containing alignment layer 12. The spectral transmittance and the retardation of the optical compensation film 10 were measured. Regarding the liquid crystal display device 40, the maximum distance at which the operation by a remote controller can be performed and the luminance reduction ratio at the central portion of the screen were measured. The measurement results are shown in FIG. 6A, Table 2, and Table 4.

### Example 8

In Example 8, an optical compensation film 10 and a liquid crystal display device 40 were produced as in Example 1 except that the thickness of the coating film of the mixed material for an alignment layer was 500 nm to significantly decrease the thickness of the near-infrared-absorbing material-containing alignment layer 12. The spectral transmittance and the retardation of the optical compensation film 10 were measured. Regarding the liquid crystal display device 40, the maximum distance at which the operation by a remote controller can be performed and the luminance reduction ratio at the central portion of the screen were measured. The measurement results are shown in FIG. 6B, Table 2, and Table 4.

### Comparative Example 1

In Comparative Example 1, the maximum distance at which the operation by a remote controller can be performed was measured as in Example 1 except that the power supply of the liquid crystal display device 40 was turned off. The measurement result is shown in Table 4.

### Comparative Example 2

In Comparative Example 2, an optical compensation film 10 and a liquid crystal display device 40 were produced as in Example 1 except that alignment layers were formed using an alignment layer material (polyamide-imide resin, manufactured by Toyobo Co., Ltd.; model number HR15ET) not containing a near-infrared-absorbing dye. The spectral transmittance and the retardation of the optical compensation film 10 were measured. Regarding the liquid crystal display device 40, the maximum distance at which the operation by a remote controller can be performed and the luminance reduction ratio at the central portion of the screen were measured. The measurement results are shown in FIG. 7, Table 2, and Table 4.

TABLE 1

| | Thickness | | | |
|---|---|---|---|---|
| | of coating | | | |
| | film made | | | |
| | of mixed | Average transmittance of light (%) | | |
| | material for | 400 | 850 | 40° |
| | alignment | to | to | retardation |
| | layer (nm) | 700 nm | 1,150 nm | value (nm) |
| Example 1 | 5,000 | 80 | 40 | 15 |
| Example 2 | 3,000 | 83 | 51 | 14 |
| Example 3 | 1,000 | 85 | 55 | 14 |
| Example 4 | 5,000 | 80 | 41 | 14 |
| Example 5 | 3,000 | 83 | 50 | 14 |
| Example 6 | 800 | 85 | 54 | 14 |

TABLE 2

| | Thickness | | | |
|---|---|---|---|---|
| | of coating | | | |
| | film made | | | |
| | of mixed | | | |
| | material | Average transmittance of light (%) | | |
| | for | 400 | 850 | 40° |
| | alignment | to | to | retardation |
| | layer (nm) | 700 nm | 1,150 nm | value (nm) |
| Example 7 | 8,000 | 75 | 18 | 15 |
| Example 8 | 500 | 86 | 81 | 14 |
| Comparative | — | — | — | — |
| Example 1 | | | | |
| Comparative | 5,000 | 86 | 88 | 15 |
| Example 2 | | | | |

TABLE 3

| | The maximum | |
|---|---|---|
| | distance at | |
| | which operation | |
| | with remote | Luminance |
| | controller can be | reduction |
| | performed (m) | ratio (%) |
| Example 1 | 3.4 | 5.4 |
| Example 2 | 2.4 | 2.2 |
| Example 3 | 2.1 | 0.74 |
| Example 4 | 3.4 | 5.4 |
| Example 5 | 2.4 | 2.2 |
| Example 6 | 2.1 | 0.74 |

TABLE 4

| | The maximum | |
|---|---|---|
| | distance at | |
| | which operation | |
| | with remote | Luminance |
| | controller can | reduction |
| | be performed (m) | ratio (%) |
| Example 7 | 4.5 | 10 |
| Example 8 | 1.4 | 0.2 |
| Comparative | 14 | — |
| Example 1 | | |
| Comparative | 1.4 | 0 |
| Example 2 | | |

As described above, as shown in FIGS. 4A to 4C and FIGS. 5A to 5C, in the optical compensation films 10 obtained in Examples 1 to 6, the near-infrared-absorbing material-containing alignment layer 12 has an increased absorption performance to light having a wavelength in the range of 850 to 1,150 nm, to which a light-receiving portion of a remote controller is sensitive, so that the transmittance of the light is decreased. Accordingly, near-infrared radiation emitted from the backlight light source 31 is effectively absorbed, and the amount of near-infrared radiation emitted outside the liquid crystal display device 40 can be efficiently reduced. In particular, the optical compensation films 10 can decrease the amount of radiation of three emission line peaks due to Ar which are located at 912 nm, 922 nm, and 965 nm, and an emission line peak due to Hg which is located at 1,013 nm. Accordingly, a decrease in the sensitivity of a remote controller of the display device itself caused by infrared radiation emitted from the liquid crystal display device 40, and malfunction of infrared communication devices located around the liquid crystal display device can be suppressed. On the other hand, since each of the optical compensation films 10 has a high transmittance of light in the visible range, the effect on the quality, in particular, the luminance of images of the liquid crystal display device can be reduced.

As shown in Table 4, in Comparative Example 2, the sensitivity was significantly decreased by infrared radiation emitted from the backlight, and thus, the maximum distance at which the operation with a remote controller can be performed was only 1.4 m. In contrast, as shown in Table 3, in Examples 1 and 4, the maximum distance at which the operation with a remote controller can be performed could be increased to 3.4 m while the luminance reduction ratio of the liquid crystal display device 40 could be suppressed to about 5%. A luminance reduction ratio of 5% or less is within a range in which, at present, the decrease can be sufficiently compensated for by increasing the tube current of cold cathode fluorescent lamps used in the backlight device to increase the illuminance.

Unless a process such as a step of suppressing surface reflection was performed, the luminance of a liquid crystal display device was decreased by 5% or more. Accordingly, the maximum distance at which operation with a remote controller can be performed has been contrary to maintaining a high luminance. According to the present disclosure, these two factors are compatible with each other. In addition, the optical compensation films 10 of Examples have retardation to light irradiating onto the surface of the films at an angle of 40°, as shown in Table 1. Thus, the optical compensation films 10 also have a function of a viewing-angle compensation film, which has been provided in existing liquid crystal display devices. As is apparent from the results of Examples shown in Tables 1 and 2, the removal ratio of near-infrared radiation can be controlled by changing the thickness of the alignment layer, and the thickness of the alignment layer does not affect retardation. Therefore, these parameters can appropriately designed.

The embodiments been described on the basis of embodiments and Examples. However, it should be understood that the embodiments are not limited to these examples and can be appropriately changed without departing from the spirit and scope of the present disclosure.

For example, the optical compensation member according to an embodiment may have not only a function of a filter in the near-infrared range but also a function of absorbing only a specific wavelength in the visible light range for color correction. Thus, the color reproducibility can be changed or the range of color reproduction can be increased. For example, an optical compensation member that absorbs ultraviolet light or blue light can be provided in a liquid crystal device used outdoors. In addition, the optical compensation member according to an embodiment may be used in a reflective liquid crystal display device. A reflective liquid crystal display device generally includes a reflector, a liquid crystal cell, a single optical compensation film, and a single polarizer. The optical compensation member according to an embodiment can be used as this optical compensation film.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An optical compensation member comprising:
an alignment layer; and
an optical anisotropic layer composed of liquid crystal molecules and provided on the alignment layer,
wherein the alignment layer contains an additive which suppresses transmission of light in a specific wavelength range.

2. The optical compensation member according to claim 1, wherein the additive includes a light-absorbing material which absorbs light in the specific wavelength range.

3. The optical compensation member according to claim 1, wherein the transmittance of light transmitting through the alignment layer is controlled by at least one of the concentration of the additive contained in the alignment layer and the thickness of the alignment layer.

4. The optical compensation member according to claim 1, wherein the alignment layer easily transmits light in the visible range and suppresses transmission of light in the near-infrared range included in light emitted from a backlight light source of a liquid crystal display device.

5. The optical compensation member according to claim 4, wherein the alignment layer includes an alignment layer material and a near-infrared-absorbing material used as the additive.

6. The optical compensation member according to claim 5, wherein the near-infrared-absorbing material is composed of at least one near-infrared-absorbing agent selected from the group consisting of a diimmonium compound, an aminium salt, an iminium salt, a diiminium salt, a quinone compound, a cyanine dye, a phthalocyanine compound, a naphthalocyanine compound, and a metal complex compound.

7. The optical compensation member according to claim 5, wherein the alignment layer material is a cellulose resin or a polyamide-imide resin.

8. The optical compensation member according to claim 4, wherein the average transmittance for light having a wavelength in the range of 400 to 700 nm is 85% or more.

9. The optical compensation member according to claim 4, wherein the average transmittance for light having a wavelength in the range of 850 to 1,150 mm is 80% or less.

10. A liquid crystal display device comprising:
a liquid crystal panel in which the light transmittance is controlled by changing the alignment of liquid crystal molecules in a liquid crystal cell to display an image; and
an optical compensation member including an alignment layer, and an optical anisotropic layer composed of liquid crystal molecules and provided on the alignment layer,
wherein the alignment layer contains an additive which suppresses transmission of light in a specific wavelength range, and
wherein the optical compensation member according to any one of claims 1 to 9 is provided at one side or both sides of the liquid crystal cell.

11. The liquid crystal display device according to claim 10, further comprising:
a backlight device,
wherein the liquid crystal display device functions as a transmissive liquid crystal display device.

12. A composition for an alignment layer for obtaining an alignment layer which aligns liquid crystal molecules, the composition comprising:
an alignment layer material; and
an additive which suppresses transmission of light in a specific wavelength range.

13. The composition for an alignment layer according to claim 12, wherein the additive is a light-absorbing material which absorbs light in the specific wavelength range.

14. The composition for an alignment layer according to claim 13, wherein the light-absorbing material is a near-infrared-absorbing material which easily transmits light in the visible range and which easily absorbs light in the near-infrared range.

15. The composition for an alignment layer according to claim 14, wherein the near-infrared-absorbing material is composed of at least one near-infrared-absorbing agent selected from the group consisting of a diimmonium compound, an aminium salt, an iminium salt, a diiminium salt, a quinone compound, a cyanine dye, a phthalocyanine compound, a naphthalocyanine compound, and a metal complex compound.

16. The composition for an alignment layer according to claim 14, wherein the alignment layer material is a cellulose resin or a polyamide-imide resin.

17. An alignment layer which aligns liquid crystal molecules, the alignment layer comprising:
a composition including
an alignment layer material, and
an additive which suppresses transmission of a light in a specific wavelength.

18. An alignment layer according to claim 17, wherein the additive is a light-absorbing material which absorbs light in the specific wavelength range.

19. An alignment layer according to claim 17, wherein the light-absorbing material is a near-infrared-absorbing material which easily transmits light in the visible range and which easily absorbs light in the near-infrared range.

20. An alignment layer according to claim 17, wherein the near-infrared-absorbing material is composed of at least one near-infrared-absorbing agent selected from the group consisting of a diimmonium compound, an aminium salt, an iminium salt, a diiminium salt, a quinone compound, a cyanine dye, a phthalocyanine compound, a naphthalocyanine compound, and a metal complex compound.

21. An alignment layer according to claim 17, wherein the alignment layer material is a cellulose resin or a polyamide-imide resin.
